(19) United States
(12) Patent Application Publication
(10) Pub. No.: US 2025/0292391 A1
(43) Pub. Date: Sep. 18, 2025

(54) IMAGE MATCHING DEVICE, IMAGE MATCHING METHOD, AND IMAGE MATCHING PROGRAM

(71) Applicant: NEC Corporation, Tokyo (JP)

(72) Inventors: Gaku NAKANO, Tokyo (JP); Tsubasa NAKAMURA, Tokyo (JP)

(73) Assignee: NEC Corporation, Tokyo (JP)

(21) Appl. No.: 19/063,470

(22) Filed: Feb. 26, 2025

(30) Foreign Application Priority Data
Mar. 14, 2024 (JP) 2024-040020

(51) Int. Cl. G06T 7/00; G06T 7/64

(52) U.S. Cl. CPC G06T 7/0006; G06T 7/64; G06T 2207/30116

(57) ABSTRACT

The image matching device includes an ellipse detection unit which detects ellipses around a top surface for each sleeve from an image of a plurality of sleeves, an ellipse matching unit which maps each detected ellipse to a circle of the sleeve shown in a design drawing, frontalizes the ellipses based on a correspondence relation, and measures a position error between each frontalized ellipse and corresponding circle in the design drawing, and a matching result display unit which displays the frontalized ellipses and the circles in the design drawing.

### CROSS-REFERENCE TO RELATED APPLICATION

This application is based upon and claims the benefit of priority from the prior Japanese Patent Application No. 2024-040020, filed Mar. 14, 2024, the entire contents of which are incorporated herein by reference.

### BACKGROUND OF THE INVENTION

### Technical Field

This disclosure relates to an image matching device, an image matching method, and an image matching program.

### Description of the Related Art

In order to facilitate work at a construction site, it is important to accurately and quickly perform a construction management and a progress management.

One of the subjects of construction management is sleeve construction work. Sleeve construction work is a process of installing sleeves to leave holes for pipes and cables to pass through before concrete is placed (see, for example, patent literature 1). If a sleeve is installed in an incorrect position that differs from the design drawings or if the sleeve is forgotten to be installed, the work of re-drilling the hole after the concrete has cured (core removal) occurs. Core removal may result in the loss of necessary seismic performance due to missing reinforcing bars. In addition, the entire building may need to be rebuilt. The number of sleeves increases with larger structures such as apartments and buildings. Therefore, the larger the structure, the more accurate and faster the installed sleeve inspection must be.

### CITATION LIST

### Patent Literature

[Patent Literature 1] International Publication No. 2018/06661

### Non-Patent Literature

[Non-Patent Literature 1] Juho Kannala, Mikko Salo, and Janne Heikkila. “Algorithms for Computing a Planar Homography from Conics in Correspondence,” BMVC 2006
[Non-Patent Literature 2] Hisatoshi Toriya, Itaru Kitahara, Yuichi Ohta, “Mobile Camera Localization Using Aerial-View Images,” IPSJ Transactions on Computer Vision and Applications (CVA), Vol. 6, pp. 111-119, October 2014

### SUMMARY OF THE INVENTION

However, sleeve inspection is a process of measuring each sleeve with a measuring tape and checking it against the design drawings. This process is not accurate and can lead to installation errors. In addition, since the process is performed manually, it also requires a lot of man-hours.

Patent literature 1 describes a sleeve position inspection device that reduces the load on the operator when inspecting whether the sleeve is in the correct position. That sleeve position inspection device uses a camera or other means to allow the operator to see whether the sleeve is in the proper position or not.

However, when utilizing the sleeve position inspection device described in patent literature 1, sleeve markers must be installed on each sleeve. In other words, since the sleeve markers must be installed, the man-hours required for inspection are high for a large structure.

It is an object of present invention to provide an image matching device, an image matching method, and an image matching program that can perform sleeve inspection accurately and efficiently.

The image matching device based on the present disclosure includes an ellipse detection unit which detects ellipses around a top surface for each sleeve from an image of a plurality of sleeves, an ellipse matching unit which maps each detected ellipse to a circle of the sleeve shown in a design drawing, frontalizes the ellipses based on a correspondence relation, and measures a position error between each frontalized ellipse and corresponding circle in the design drawing, and a matching result display unit which displays the frontalized ellipses and the circles in the design drawing.

The image matching method based on the present disclosure includes detecting ellipses around a top surface for each sleeve from an image of a plurality of sleeves, mapping each detected ellipse to a circle of the sleeve shown in a design drawing, frontalizing the ellipses based on a correspondence relation, and measuring a position error between each frontalized ellipse and corresponding circle in the design drawing, and displaying the frontalized ellipses and the circles in the design drawing.

The image matching program based on the present disclosure causes a computer to execute a process of detecting ellipses around a top surface for each sleeve from an image of a plurality of sleeves, a processes of mapping each detected ellipse to a circle of the sleeve shown in a design drawing, frontalizing the ellipses based on a correspondence relation, and measuring a position error between each frontalized ellipse and corresponding circle in the design drawing, and a process of displaying the frontalized ellipses and the circles in the design drawing.

According to present invention, sleeve inspection can be performed accurately and efficiently.

### BRIEF DESCRIPTION OF THE DRAWINGS

FIG. 1: It depicts a block diagram showing a configuration example of an image matching device.

FIG. 2: It depicts a flowchart showing the processing of an image matching device.

FIG. 3: It depicts an explanatory diagram for explaining a specific example of image matching.

FIG. 4: It depicts an explanatory diagram for explaining a specific example of the input/output of an image matching device.

FIG. 5: It depicts a block diagram showing a configuration example of another image matching device.

FIG. 6: It depicts a flowchart showing the processing of an image matching device.

FIG. 7: It depicts a block diagram showing a configuration example of still another image matching device.

FIG. 8: It depicts a flowchart showing the processing of an image matching device.

FIG. 9A: It depicts an explanatory diagram for explaining sleeve height misalignment.

FIG. 9B: It depicts an explanatory diagram for explaining sleeve height misalignment.

FIG. 10: It depicts a block diagram showing a configuration example of another image matching device.

FIG. 11: It depicts a flowchart showing the processing of an image matching device.

FIG. 12: It depicts a schematic block diagram showing an example of a computer configuration.

### DESCRIPTION OF THE PREFERRED EMBODIMENTS

Hereinafter, example embodiments will be explained with reference to the drawings.

First example embodiment.

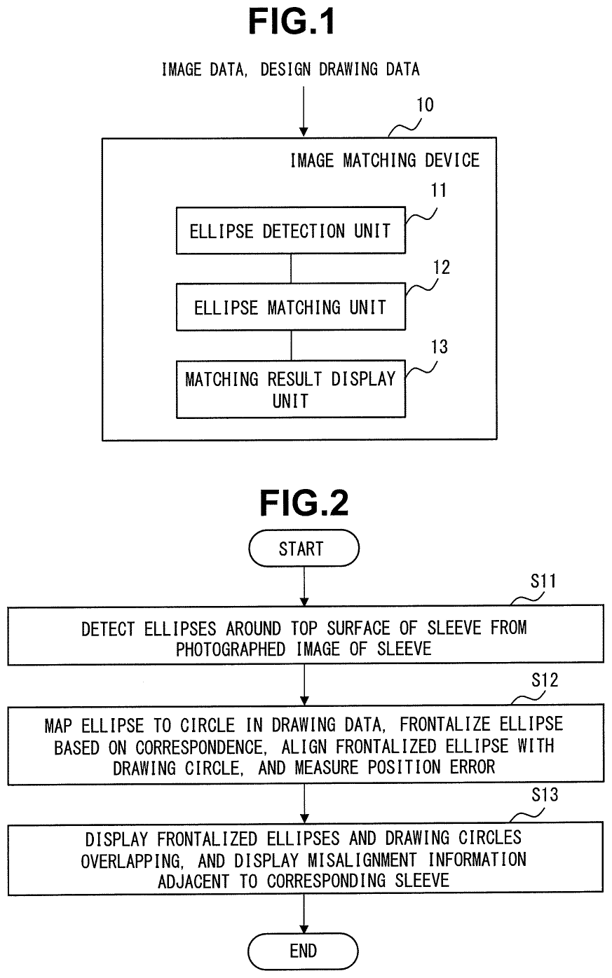

FIG. 1 is a block diagram showing a configuration example of an image matching device. The image matching device 10 shown in FIG. 1 is a device that accepts as input image data in which sleeves are photographed and design drawing data of the sleeves, and matches sleeve positions in the image data with sleeve positions in the drawing data. The image matching device 10 comprises an ellipse detection unit 11, an ellipse matching unit 12, and a matching result display unit 13.

### [Description of Structure]

The ellipse detection unit 11 is input with image data in which the sleeves are captured by an imaging device such as a camera (not shown). The ellipse detection unit 11 detects areas around the top surface of the sleeves as ellipses from an image based on the input image data. It is assumed that the image shows two or more sleeves. This is because if there is only one sleeve at the site, it is easy to measure it manually. The image is one or more images photographed from an overhead view of the location where the sleeves have been installed.

The design drawing data of the sleeves is input to the image matching device 10. The design drawing data is input, for example, by an inspector through an input device (not shown). The ellipse matching unit 12 first determines which sleeve in the design drawing corresponds to each of the two or more ellipses detected. On the plan view, the sleeve is described as a circle. Therefore, the ellipse matching unit 12 maps ellipses to circles. Next, the ellipse matching unit 12 frontalizes the ellipses based on the correspondence relation between two or more ellipses and circles. The ellipse matching unit 12 then aligns the frontalized ellipses with the circles in the design drawing. Hereinafter, the circle in the design drawing is referred to as the drawing circle. Furthermore, the ellipse matching unit 12 measures position errors. The position error is a difference between the center coordinates of the frontalized ellipse and the drawing circle. Frontalization means that the coordinates are transformed so that the object faces the front (frontal transformation).

The matching result display unit 13 displays the frontalized ellipses and the drawing circles overlapping on a display device (display device: not shown). The matching result display unit 13 also displays the measured position error adjacent to each sleeve on the display screen of the display device. The matching result display unit 13 may include a display device.

### [Description of Operation]

Next, an operation of image matching device 10 will be explained with reference to FIG. 2 refer to FIG. 2. FIG. 2 is a flowchart showing the processing of the image matching device 10.

When an image data in which sleeves have been photographed design drawing data of sleeves are input to the image matching device 10, the ellipse detection unit 11 detects areas around the top surfaces of the sleeves as ellipses from the image and outputs them (step S11).

Next, when drawing data is input and ellipses are input from the ellipse detection unit 11, the ellipse matching unit 12 first determines for each ellipse which sleeve of the design drawing corresponds to which circle. Next, the ellipse matching unit 12 frontalizes the ellipses based on the correspondence relation between the ellipses and the circles. Then, the ellipse matching unit 12 aligns the frontalized ellipses with the drawing circles and outputs a measured position error to the matching result display unit 13 (step S12).

When the frontalized ellipses, drawing circles, and the position errors are input to the matching result display unit 13, the matching result display unit 13 displays the frontalized ellipses and the drawing circles overlapping, and displays the position error adjacent to respective sleeves (step S13).

Next, a specific example of image matching will be explained.

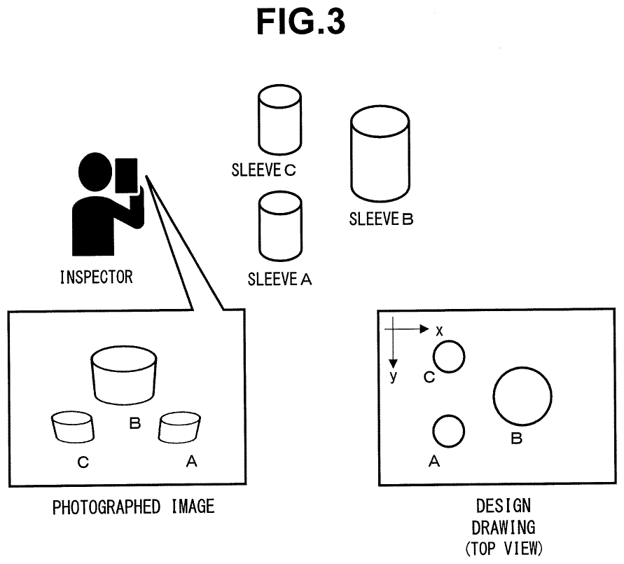

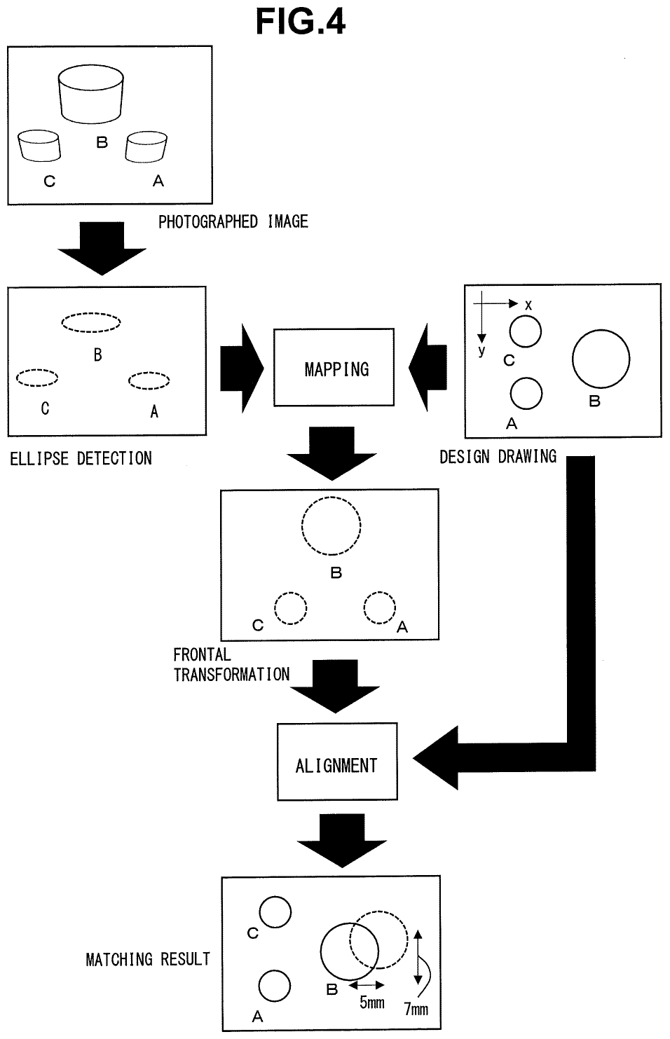

FIG. 3 is an explanatory diagram for explaining a specific example of image matching. FIG. 3 shows a scene in which three sleeves are installed, and an inspector photographs the three sleeves (A, B, C) with an inspection terminal (including an imaging unit) and matches them with a design drawing. FIG. 4 is an explanatory diagram for explaining a specific example of the input/output of an image matching device.

In step S11 above, the ellipse detection unit 11 detects each area around the top surface of the sleeve as an ellipse from the image photographed by the inspection terminal. Generally, a sleeve is a cylinder. Therefore, its top surface is observed as an ellipse in the image. To detect ellipses, the ellipse detection unit 11 can, for example, apply image processing that binarizes the image and performs ellipse fitting to the edges of top surface of the sleeve. The sleeve upper surface may be colored or patterned so that the edges stand out, and the ellipse detection unit 11 may detect an ellipse by color extraction or pattern recognition. The inspector may also manually specify the ellipse by, for example, tracing the top surface of the sleeve on the screen with a finger.

Next, in step S12, the ellipse matching unit 12 determines for each of the ellipses which of the ellipses corresponds to the circle representing which sleeve in the design drawing. In the examples shown in FIGS. 3 and 4, the ellipse matching unit 12 determines which ellipses A-C correspond to drawing circles A-C. The A-C in “Ellipse Detection” in FIG. 4 correspond to ellipses A-C. Also, A-C in “Design Drawing” in FIG. 4 correspond to drawing circles A-C.

When mapping ellipses to circles, for example, the correspondence may be determined manually one by one by the inspector. For example, when the size of each sleeve is different, since the magnitude relation of the ellipses on the screen and the magnitude relation of the circles in the drawing should generally be the same, the ellipse matching unit 12 may determine the correspondence relation based on the size of the sleeve,. The ellipse matching unit 12 may, for example, determine the distribution of the center coordinates of ellipses A-C and drawing circles A-C by the ICP (Iterative Closest Point) method.

Once ellipses A-C is mapped to drawing circles A-C, the ellipse matching unit 12 frontalizes the ellipses A-C using the correspondence information (information indicating a correspondence relation, i.e., which ellipses correspond to which drawing circles). The method of frontal transformation may be, for example, the method described in non-patent literature 1. That is, the ellipse matching unit 12 can calculate the planar projection transformation matrix from the ellipses A-C to the drawing circles A-C and apply the planar projection transformation to the ellipses A-C. Once the ellipse A˜C is frontalized, the ellipse matching unit 12 aligns the frontalized ellipses A-C with the drawing circles A-C based on the correspondence information. The alignment is a 2-dimensional rigid transformation (rotation and translation) from the frontalized ellipses (ellipses which have been frontalized) A-C to the drawing circles A-C.

In order to automatically map and align the ellipses A-C and the drawing circles A-C as described above, the following may be used. The simplest method is to search for all combinations of correspondence between the ellipses A-C and the drawing circles A-C and perform a plane projective transformation using the method described in non-patent literature 1 for each single combination. The number of combinations is proportional to the square of the number of ellipses. However, there is only one combination in which the ellipses A-C are perfect circles after plane projective transformation. Therefore, the search should be terminated when the frontalized ellipses become perfect circles. In addition, the search can be terminated even earlier by combining it with RANSAC (Random Sample Consensus) instead of an exhaustive search.

In step S13, the matching result display unit 13 displays the frontalized ellipses and the drawing circles overlapping on the display device. Furthermore, the matching result display unit 13 displays the position errors adjacent to the respective sleeves on the display screen of the display device. When the image resolution of the frontalized ellipses A-C and the drawing circles A-C are matched, the error expressed in pixels on the image can be converted to the actual size error in meters. To improve visibility, the matching result display unit 13 may display the position error only when the position error is large (e.g., 1 mm or more). In other words, the matching result display unit 13 may display the position error when the position error exceeds a predetermined threshold.

### [Effect of the First Example Embodiment]

The image matching device 10 of this example embodiment can accurately and efficiently perform sleeve inspection.

The reason is that since the sleeve position is matched with the image in which the sleeve is photographed and the design drawing, it does not need to measure the position of each sleeve with a tape measure. Specifying the center of a sleeve by hand is difficult and involves large measurement errors. However, in this example embodiment, the center of the ellipse can be estimated with high accuracy by image processing. When the measurement error of the sleeve is large, the sleeve position can be corrected before concrete is placed. In the case of forgotten installation, the correspondence between the photographed image and the drawing fails because the number of sleeves is different. As a result, the inspector can notice the forgotten installation. Therefore, the operator can install the forgotten sleeves before placing concrete.

### Second Example Embodiment.

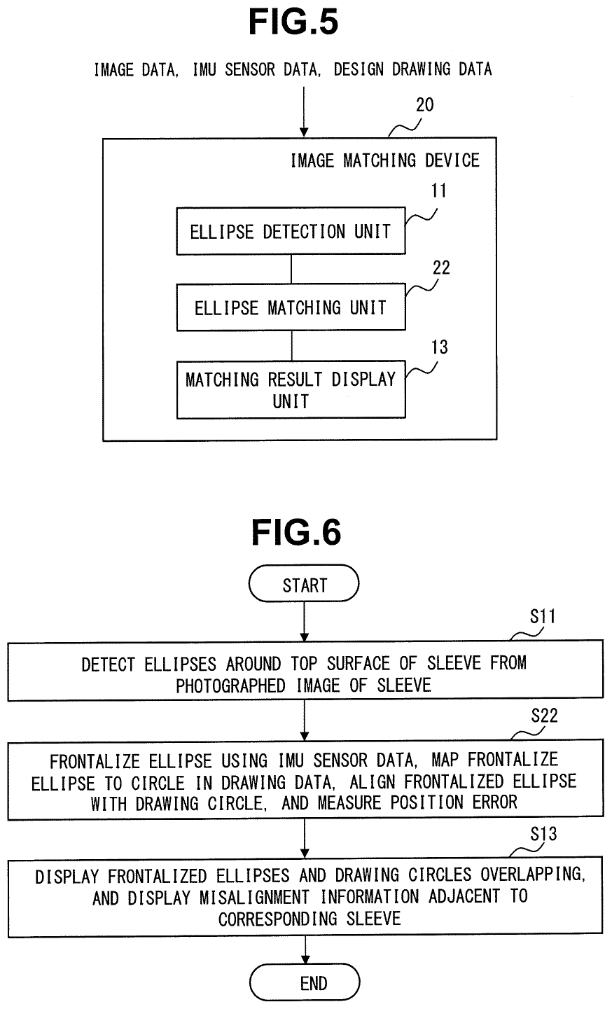

FIG. 5 is a block diagram showing another configuration example of an image matching device. The image matching device 20 shown in FIG. 5 comprises then ellipse detection unit 11 that performs ellipse matching using IMU sensor data at the ellipse matching unit 22, the ellipse matching unit 22, and the matching result display unit 13. In addition to the image data in which the sleeves are photographed and the sleeve design drawing data, the image matching device 20 accepts as input the IMU (Inertial measurement Unit) sensor data corresponding to the image data in which the sleeves are photographed.

In the image matching device 20, the ellipse matching unit 22 performs ellipse matching using IMU sensor data. The IMU sensor is a sensor that measures inertia, consisting of an accelerometer and a gyro.

The configuration and functions of the ellipse detection unit 11 and the matching result display unit 13 are the same as those in the first example embodiment.

### [Description of Structure]

The ellipse matching unit 12 frontalizes ellipses detected by the ellipse detection unit 11 using the IMU sensor data. Next, the ellipse matching unit 12 maps the frontalized ellipses to the drawing circles. The ellipse matching unit 12 then aligns the frontalized ellipse with the drawing circles and measures the position errors.

### [Description of Operation]

Next, the operation of the image matching device 20 will be described with reference to FIG. 6. FIG. 6 is a flowchart showing the processing of the image matching device 20.

The process in step S11 is the same as in the first example embodiment.

When IMU sensor data corresponding to an image photographed by a camera or other imaging device, drawing data, and ellipses output from the ellipse detection unit 11 are input to the ellipse matching unit 22, the ellipse matching unit 22 uses the IMU sensor data to frontalize the ellipses detected by the ellipse detection unit 11. The ellipse matching unit 22 then maps the frontalized ellipses to the drawing circles. Then, the ellipse matching unit 22 aligns the frontalized ellipses with the drawing circles and outputs the position errors (step S22).

The process in step S13 is the same as in the first example embodiment.

Next, a specific example of image matching is described. It is known that IMU sensor data can be used to frontalize an image photographed from an overhead view of the floor as if it were photographed vertically from the sky (for example, see non-patent literature 2).

The ellipse matching unit 22 can directly transform the detected ellipse to frontal by using the sensor data and the method described in non-patent literature 2. After the frontal transformation is performed, the ellipse matching unit 22 can complete the mapping and the alignment by performing the ICP method of a 2-dimensional rigid transformation as in one example in the first example embodiment.

### [Effect of the Second Example Embodiment]

The image matching device 20 of this example embodiment, the ellipse matching unit 22 can perform the matching process at a higher speed.

The reason is that since the ellipse matching unit 22 performs frontal transformation using IMU sensor data, it does not need to perform calculation of the plane projection transformation described in non-patent literature 1, for example. In other words, since a full combination search for mapping the ellipses A-C to the drawing circles A-C is no longer necessary, the process is faster.

### Third Example Embodiment.

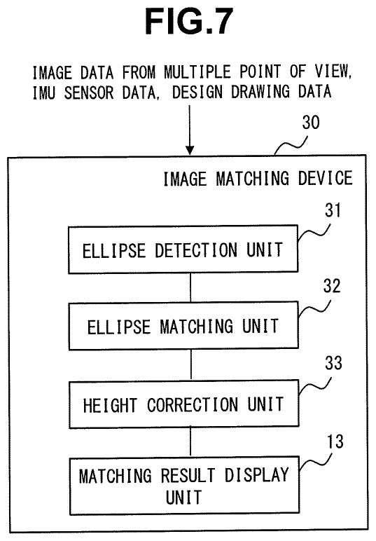

FIG. 7 is a block diagram showing still another configuration example of an image matching device. The image matching device 30 shown in FIG. 7 comprises an ellipse detection unit 31, an ellipse matching unit 32, a height correction unit 33, and the matching result display unit 13. In addition to the sleeve design drawing data, the image matching device 30 accepts as input image data of multiple images (an image group) of the sleeve photographed from multiple points (as an example, two points) and IMU sensor data corresponding to each image data. The height correction unit 33 corrects a height direction of the sleeve using the IMU sensor data and the frontalized ellipse.

The configuration and functions of the matching result display unit 13 are the same as those in the first example embodiment.

### [Description of Structure]

The ellipse detection unit 31 detects areas around the top surface of thesleeves as ellipses from each of multiple images (an image group) of the sleeve photographed from multiple points. For each of the detected multiple ellipses, the ellipse matching unit 32 frontalizes the ellipses based on the correspondence relation between the ellipse and the circle or by using IMU sensor data. Then, the ellipse matching unit 32 aligns each of the frontalized ellipses with the drawing circle and measures the position error of each.

The height correction unit 33 estimates height misalignment of the sleeve from the reference plane using the IMU sensor data and the frontalized ellipses input from the ellipse matching unit 12. The height correction unit 33 also corrects the position error between the frontalized ellipse and the drawing circle.

### [Description of Operation]

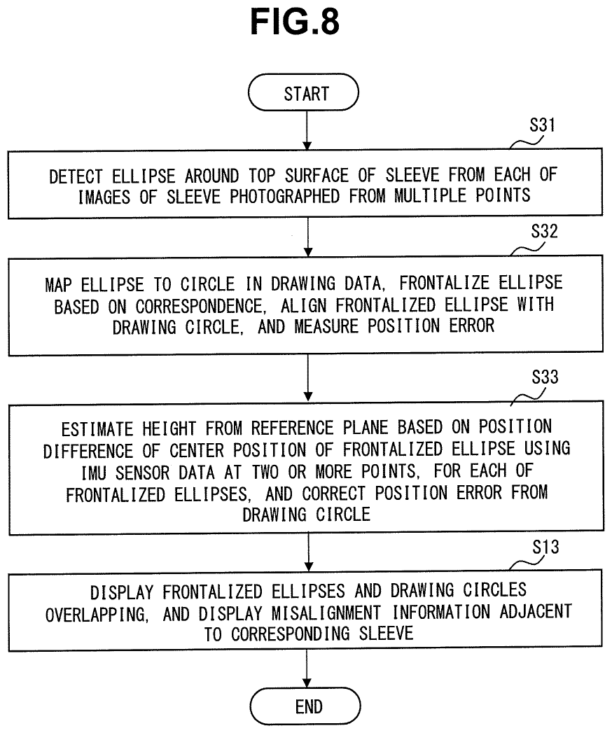

Next, the operation of the image matching device 30 will be described with reference to FIG. 8. FIG. 8 is a flowchart showing the processing of the image matching device 30.

When image data of multiple images of a sleeve photographed from multiple points and design drawing data of the sleeve are input to the image matching device 30, the ellipse detection unit 31 detects areas around the top surface of the sleeves as ellipses from each of the multiple images and outputs them (step S31).

Next, when drawing data is input and ellipses are input from the ellipse detection unit 31, the ellipse matching unit 32 first determines for each ellipse which sleeve of the design drawing corresponds to which circle. Next, the ellipse matching unit 32 frontalizes the ellipses. The ellipse matching unit 12 then aligns the frontalized ellipses with the drawing circles and outputs the measured position errors to the height correction unit 33 (step S32).

The ellipse matching unit 32 performs the process described above for each of the multiple images photographed from multiple locations.

In this example embodiment, when the height correction unit 33 inputs the IMU sensor data and the frontalized ellipse from the ellipse matching unit 32, the height correction unit 33 first estimates the height misalignment of the sleeve from the reference plane. Next, the height correction unit 33 corrects the position error between the frontalized ellipse and the drawing circle (step S33).

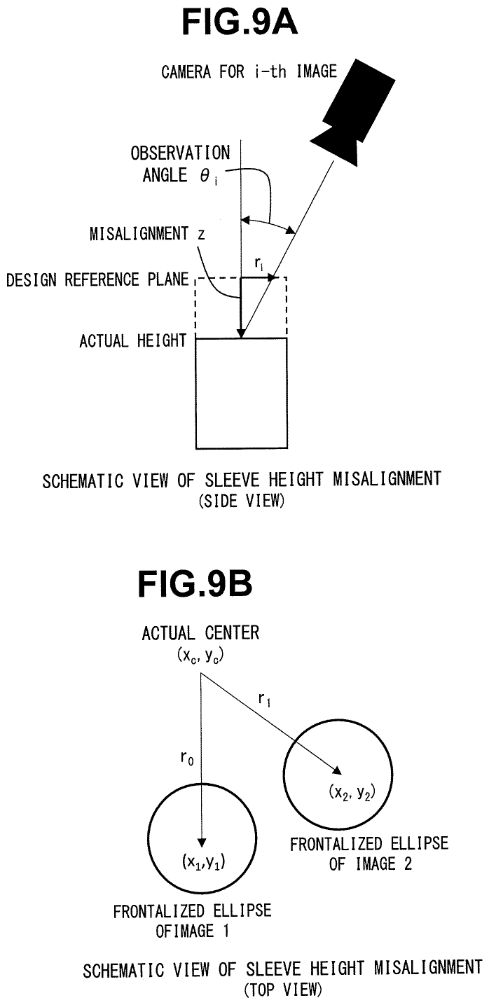

Hereinafter, the process by the height correction unit 33 will be explained. FIGS. 9A and 9B are explanatory diagrams for explaining sleeve height misalignment. FIG. 9A shows a schematic side view of the sleeve height out of alignment from the design reference plane photographed from two different points. FIG. 9B shows a schematic top view of the sleeve height out of alignment from the design reference plane, photographed from two different points. In FIG. 9B, image 1 is an image photographed from one point. Image 2 is an image photographed from the other point. The frontalized ellipse of image 1 and the the frontalized ellipse of image 2 correspond to frontalized ellipses in each image corresponding to the same circle (one circle) in the design drawing.

In FIG. 9A, suppose that z is the misalignment (height misalignment) between the design reference plane and the actual sleeve height, θᵢ is the observation angle between a camera that observes the i-th image and the vertical direction, and rᵢ (position difference) is the apparent length of z in the i-th image. In FIG. 9B, suppose that (xᵢ, yᵢ) is the center position of the frontalized ellipse in the i-th image, (x_{c}, y_{c}) is the actual center position, and q is the angle between the actual center position and the center positions of the two frontalized ellipses. Here, z, (x_{(c}), y_{c}) and φ are unknown values.

The height correction unit 33 can obtain the observation angle θᵢ from the gravity direction of the IMU sensor data. The relationship rᵢ=z*tan (θᵢ) holds between the height misalignment z and the apparent length rᵢ. The relationship between the center position of the frontalized ellipse and the actual center position is expressed by the following equation.

$$\begin{matrix}( {x}_{1} - {x}_{c} , {y}_{1} - {y}_{c} ) = ( 0 , {r}_{1} ) \\ ( {x}_{2} - {x}_{c} , {y}_{2} - {y}_{c} ) = ( {r}_{2} * sin ( φ ) , {r}_{2} * cos ( φ ) )\end{matrix} \qquad Equation 1$$

The upper expression in Equation 1 can be transformed as x_{c}=x₁ and y_{c}=y₁−r₁, which can be substituted into the lower expression in Equation 1 to obtain the following equation.

$$\begin{matrix}{x}_{2} - {x}_{1} = z * tan ( {θ}_{2} ) * sin ( φ ) \\ {y}_{2} - {y}_{1} + z * tan ( {θ}_{1} ) = z * tan ( {θ}_{2} ) * cos ( φ )\end{matrix} \qquad Equation 2$$

If both sides are squared and added, based on cos (φ)∧2+sin (φ)∧2=1, can be eliminated and becomes a quadratic about z. Therefore, two solutions for z are obtained. Substituting them into Equation 2, (x_{c}, y_{c}) and φ are calculated. The reason why two different solutions is obtained is that Equation 2 is squared.

The height correction unit 33 can uniquely determine the solution as follows. For example, when images at three different points are used, a total of six z can be calculated. However, three of them should theoretically are the same value. Therefore, the height correction unit 33 should search for the three values that are close and calculate an average value. For example, when the misalignment z is assumed to be small, the height correction unit 33 may select the one with the smaller absolute value of z even from the images at the two points.

Hereinafter, the above specific examples will be explained in relation to the operation of the image matching device 30.

In step S33, when the IMU sensor data of images photographed from two or more different points and the frontalized ellipse output by the ellipse matching unit 12 using those images are input, the height correction unit 33 first calculates the height misalignment z of the sleeve from the reference plane by solving Equation 2. Next, the height correction unit 33 calculates the center position (x_{c}, y_{c}) of the actual frontalized ellipse. Then, the height correction unit 33 recalculates the position error between the frontalized ellipse and the drawing circle.

The process in step S13 is the same as in the first example embodiment.

### [Modification]

Correction processing by the height correction unit 33 in the third example embodiment is not limited to the processing described above. Some modifications of the correction process are described below.

### Modification 3-1

The method by which the height correction unit 33 estimates the height misalignment and the actual center position is not limited to solving Equation 2. For example, the method by which the height correction unit 33 may convert detected ellipse the detection ellipse may be converted to three dimensions using a method to recover the three-dimensional motion of the camera from the image corresponding points, called Structure-from-Motion. Structure-from-Motion is a widely known theory and method in computer vision.

### Modification 3-2

The ellipse matching unit 12 may perform frontalization of detected ellipses as the ellipse matching unit 22 using IMU sensor data.

### [Effect of the Third Example Embodiment]

The image matching device 30 of this example embodiment can measure position errors with high accuracy for sleeves of different heights.

### The Reasons are as Follows

In the first and second example embodiments, it is assumed that the sleeve heights are identical (i.e., top surfaces of the sleeves are on the same plane). When the heights are not identical, the position of the frontalized ellipse will be out of alignment horizontally, as illustrated in FIG. 9B. Therefore, the misalignment would be excessive compared to the actual misalignment. By using image data taken from multiple points, as in this example embodiment, the height correction unit 33 can solve, for example, Equation 2 or Structure-from-Motion. As a result, the height correction unit 33 can correct the height misalignment of the sleeve and calculate the actual center position of the frontalized ellipse.

### Fourth Example Embodiment.

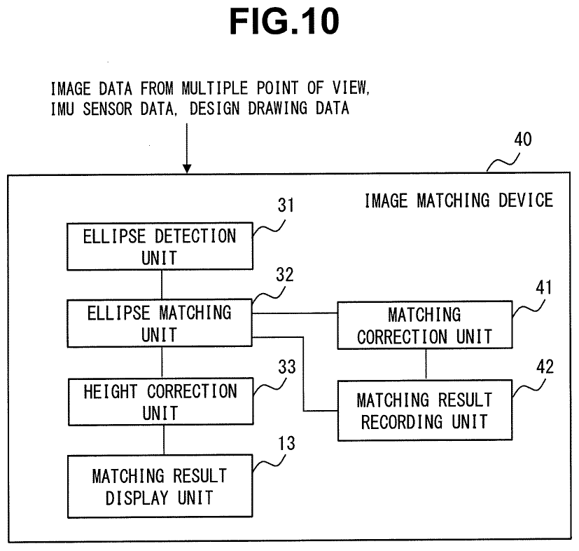

FIG. 10 is a block diagram showing a configuration example of yet another image matching device. The image matching device 40 shown in FIG. 10 comprises the ellipse detection unit 31, the ellipse matching unit 32, the height correction unit 33, the matching result display unit 13, a matching correction unit 41, and a matching result recording unit 42.

The configuration of the image matching device 40 is the image matching device 30 of the third example embodiment, in which the matching correction unit 41 and matching result recording unit 42 are incorporated. However, the image matching device 10 of the first example embodiment and the image matching device 20 of the second example embodiment may also incorporate the matching correction unit 41 and the matching result recording unit 42.

### [Description of Structure]

When the correction of the correspondence information between the frontalized ellipse and the drawing circle is input from an inspector, the matching correction unit 41 overwrites the correspondence information output from the ellipse matching unit 32, that is, the correspondence information determined by the ellipse matching unit 32, with the correction information, and outputs the result of the overwriting to the ellipse matching unit 12 as corrected correspondence information. When the position error between the frontalized ellipse and the drawing circle is input from the ellipse matching unit 32, the matching result recording unit 42 records the position error on an inspection form.

### [Description of Operation]

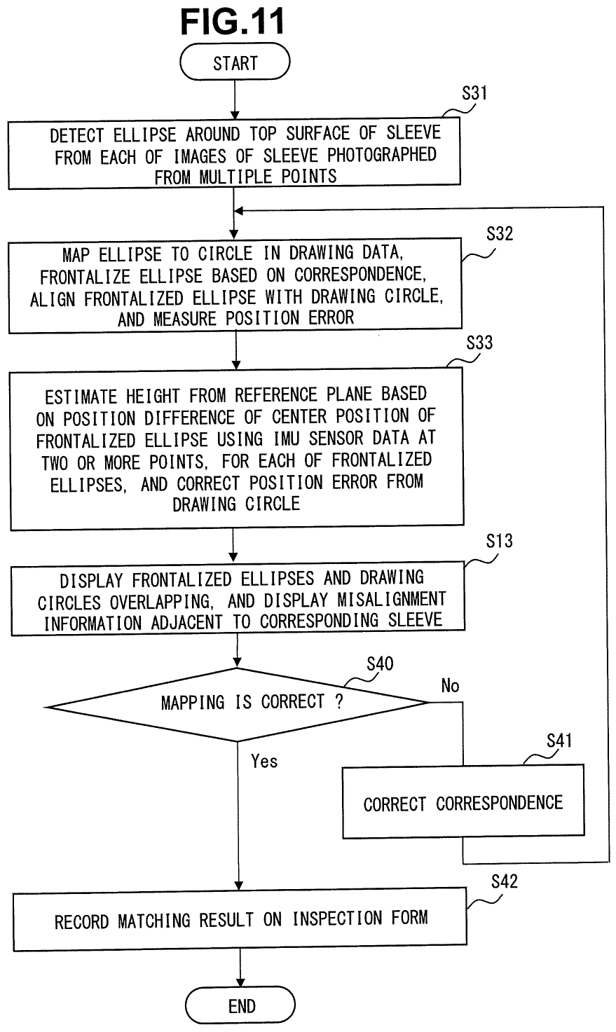

Next, the operation of the image matching device 40 will be described with reference to FIG. 11. FIG. 11 is a flowchart showing the processing of the image matching device 40.

The processes of steps S31-S33 and S13 are the same as in the third example embodiment.

When the matching correction unit 41 inputs correct of the correspondence information between the frontalized ellipse and the drawing circle from the inspector, i.e., when the correspondence information is incorrect (step S40), the matching correction unit 41 corrects the correspondence information that has already been determined by the ellipse matching unit 32 (step S41). Then, the matching correction unit 41 outputs the corrected correspondence information to the matching result recording unit 42.

The matching result recording unit 42 records the position error between the frontalized ellipse and the drawing circle output from the ellipse collation unit 42 on an inspection form (step S42). The inspection form is stored as inspection form data, for example, in a storage device (not shown) that the image matching device 40 has or that exists outside the image matching device 40.

Hereinafter, a specific example of the process of modifying correspondence information and recording the inspection form will be explained.

The inspector confirms the correspondence information between the frontalized ellipse and the drawing circle displayed on the display device (not shown) by the matching result display unit 13. When the inspector determines that the correspondence information is incorrect, the inspector inputs the correct correspondence information to the image matching device 40 through the input device (not shown). In the image matching device 40, the ellipse matching unit 32 and the height correction unit 33 execute the ellipse matching and height correction processes (the processes in steps S32 and S33) again using the corrected correspondence information.

Then, the inspector confirms the correspondence information between the frontalized ellipse and the drawing circle displayed on the display device and the position error. When no errors are found, the inspector inputs a recording instruction to the image matching device 40 through the input device. In the image collation device 40, the matching result recording unit 42 records the position error between the frontalized ellipse and the drawing circle on the inspection form. Once successfully recorded, the image matching device 40 terminates operation.

### [Modification]

The processing by the matching correction unit 41 in the fourth example embodiment is not limited to the processing described above. Modifications are described below.

### Modification 4-1.

The matching correction unit 41 may accept as input the three-dimensional coordinates in the world coordinate system of one or more frontalized ellipses. The world coordinate system is a reference point (reference line) that matches the coordinate system between the measurement site and the design drawing, called “offset marking line”.

In all of the first to four example embodiments, the correctness of the relative distance between the sleeves is measured. Therefore, it is not clear whether the absolute distance from the “offset marking line” is correct or not. For example, if the distance from the offset marking line for only one sleeve is measured by a tape measure and the value is fixed as the coordinate value of the frontalized ellipse, the output of the ellipse matching unit 12, 22, 32 can be converted to the measurement result in the world coordinate system.

### [Effect of the Fourth Example Embodiment]

Even if incorrect correspondence information is output from the ellipse matching unit 32, the image matching device 40 of this example embodiment can work with the inspector to properly correct the correspondence information. Therefore, an accurate inspection form can be automatically generated.

In this example embodiment, both the matching correction unit 41 and the matching result recording unit 42 are provided, but only the matching correction unit 41 may be provided. The matching result recording unit 42 may be provided in the image collation devices 10-30 of the first to third example embodiments.

Each function (each process) in the above example embodiments can be realized by a computer having a processor such as a CPU, memory, etc. For example, a program for implementing the method (processing) in the above example embodiments may be stored in a memory device (memory medium), and each function may be realized by executing the program stored in the memory device by a CPU.

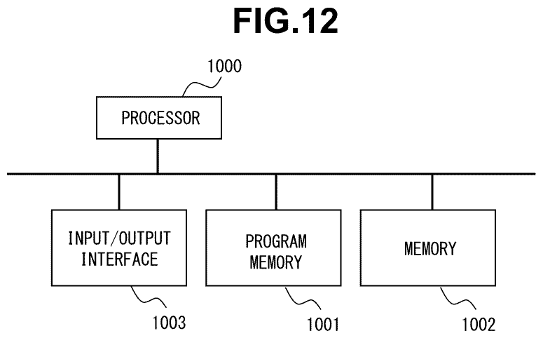

FIG. 12 is a block diagram showing an example configuration of a computer capable of realizing the image matching devices 10-40. The computer shown in FIG. 12 includes a processor 1000 such as a CPU, a program memory 1001, a memory 1002, and an input/output interface 1003.

The image matching devices 10-40 shown in FIGS. 1, 5, 7, and 10 can be realized by software. That is, for example, the functions of each block in the image matching devices 10-40 can be realized by the processor 1000 executing processing in accordance with a program stored in the program memory 1001 in the computer illustrated in FIG. 12. When multiple processors are installed, the functions of the image matching devices 10-40 can also be realized by multiple processors working together.

The program memory 1001 is, for example, a non-transitory computer readable media. The non-transitory computer readable medium is one of various types of tangible storage media. For example, a semiconductor storage medium such as a flash ROM (Read Only Memory) or a magnetic storage medium such as a hard disk can be used as the program memory 1001. The program memory 1001 stores an image matching program to realize the functions of the image matching devices 10-40 of the above example embodiments.

Semiconductor or magnetic storage media can be used as the memory 1002. The memory 1002 stores temporary data and other data generated when the image matching devices 10-40 are executing processing. It can be assumed that an image matching program is transferred to the memory 1002 and the processor 1000 executes processing based on the program in the memory 1002. The program memory 1001 and the memory 1002 may be integrated into a single unit.

The memory 1002 can be used as the storage device to store inspection forms.

The input/output interface 1003 implements functions for information (data) input/output. The input/output interface 1003 includes input circuitry for the examiner to input information to the image matching devices 10-40, for example.

A part of or all of the above example embodiments may also be described as, but not limited to, the following supplementary notes.

### (Supplementary Note 1)

An image matching device comprising:
an ellipse detection unit which detects ellipses around a top surface for each sleeve from an image of a plurality of sleeves,
an ellipse matching unit which maps each detected ellipse to a circle of the sleeve shown in a design drawing, frontalizes the ellipses based on a correspondence relation, and measures a position error between each frontalized ellipse and corresponding circle in the design drawing, and
a matching result display unit which displays the frontalized ellipses and the circles in the design drawing.

### (Supplementary Note 2)

The image matching device according to Supplementary note 1, wherein
the matching result display unit displays the position error adjacent to the frontalized ellipse and the circle in the design drawing.

### (Supplementary Note 3)

The image matching device according to Supplementary note 1 or 2, wherein
the ellipse matching unit inputs IMU sensor data corresponding to the image in which the sleeve is photographed, frontalizes the detected ellipse using the IMU sensor data, and measures the position error by mapping the frontalized ellipse to the circle in the design drawing.

### (Supplementary Note 4)

The image matching device according to Supplementary note 3,
wherein the ellipse matching unit frontalizes the detected ellipse for each image in a group of images consisting of multiple images including the sleeve photographed from multiple points, and
wherein the image matching device further comprises a height correction unit which estimates a height of the sleeve from a reference plane based on position differences between the frontalized ellipses, in each image, corresponding to the same circle in the design drawing, and corrects the position error between the frontalized ellipse and the circle in the design drawing.

### (Supplementary Note 5)

The image matching device according to any one of Supplementary notes 1 to 4, further comprising
a matching correction unit which, when a correction of correspondence information indicating a correspondence relationship between the frontalized ellipse and the circle in the design drawing is input, corrects the correspondence information determined by the ellipse matching unit based on the input correction, and output the corrected correspondence information to the ellipse matching unit.

### (Supplementary Note 6)

The image matching device according to any one of Supplementary notes 1 to 5, further comprising
a matching result recording which records the position error between the frontalized ellipse output from the ellipse matching unit and the circle in the design drawing on a form.

### (Supplementary Note 7)

The image matching device according to Supplementary note 5, wherein
the matching correction unit accepts as input three-dimensional coordinates in a world coordinate system of one or more of the frontalized ellipses.

### (Supplementary Note 8)

An image matching method comprising:
detecting ellipses around a top surface for each sleeve from an image of a plurality of sleeves,
mapping each detected ellipse to a circle of the sleeve shown in a design drawing, frontalizing the ellipses based on a correspondence relation, and measuring a position error between each frontalized ellipse and corresponding circle in the design drawing, and
displaying the frontalized ellipses and the circles in the design drawing.

### (Supplementary Note 9)

An image matching program for causing a computer to execute:
a process of detecting ellipses around a top surface for each sleeve from an image of a plurality of sleeves,
a processes of mapping each detected ellipse to a circle of the sleeve shown in a design drawing, frontalizing the ellipses based on a correspondence relation, and measuring a position error between each frontalized ellipse and corresponding circle in the design drawing, and
a process of displaying the frontalized ellipses and the circles in the design drawing.

### (Supplementary Note 10)

A computer readable storage medium for storing an image matching program for causing a computer to execute:
a process of detecting ellipses around a top surface for each sleeve from an image of a plurality of sleeves,
a processes of mapping each detected ellipse to a circle of the sleeve shown in a design drawing, frontalizing the ellipses based on a correspondence relation, and measuring a position error between each frontalized ellipse and corresponding circle in the design drawing, and
a process of displaying the frontalized ellipses and the circles in the design drawing.

Some or all of the configurations described in Supplementary notes 2 through 7, which are subordinate to Supplementary note 1 described above, can be subordinated to Supplementary notes 8 through 10 according to the same subordination relationship as Supplementary notes 2 through 7. Furthermore, not limited to Supplementary note 1, Supplementary note 8, Supplementary note 9, and Supplementary note 10, some or all of the configurations described in Supplementary notes above may be subordinated to various hardware, software, various recording means for recording software, or systems, provided that no deviation from the example embodiments described above.

Although the invention of the present application has been described above with reference to example embodiments, the present invention is not limited to the above example embodiments. Various changes can be made to the configuration and details of the present invention that can be understood by those skilled in the art within the scope of the present invention.

What is claimed is:

1. An image matching device comprising:
an ellipse detection unit which detects ellipses around a top surface for each sleeve from an image of a plurality of sleeves,
an ellipse matching unit which maps each detected ellipse to a circle of the sleeve shown in a design drawing, frontalizes the ellipses based on a correspondence relation, and measures a position error between each frontalized ellipse and corresponding circle in the design drawing, and
a matching result display unit which displays the frontalized ellipses and the circles in the design drawing.

2. The image matching device according to claim 1, wherein
the matching result display unit displays the position error adjacent to the frontalized ellipse and the circle in the design drawing.

3. The image matching device according to claim 1, wherein
the ellipse matching unit inputs IMU sensor data corresponding to the image in which the sleeve is photographed, frontalizes the detected ellipse using the IMU sensor data, and measures the position error by mapping frontalized ellipse to the circle in the design drawing.

4. The image matching device according to claim 3,
wherein the ellipse matching unit frontalizes the detected ellipse for each image in a group of images consisting of multiple images including the sleeve photographed from multiple points, and
wherein the image matching device further comprises a height correction unit which estimates a height of the sleeve from a reference plane based on position differences between the frontalized ellipses, in each image, corresponding to the same circle in the design drawing, and corrects the position error between the frontalized ellipse and the circle in the design drawing.

5. The image matching device according to claim 1, further comprising
a matching correction unit which, when a correction of correspondence information indicating a correspondence relationship between the frontalized ellipse and the circle in the design drawing is input, corrects the correspondence information determined by the ellipse matching unit based on the input correction, and output the corrected correspondence information to the ellipse matching unit.

6. The image matching device according to claim 1, further comprising
a matching result recording which records the position error between the frontalized ellipse output from the ellipse matching unit and the circle in the design drawing on a form.

7. The image matching device according to claim 5, wherein
the matching correction unit accepts as input three-dimensional coordinates in a world coordinate system of one or more of the frontalized ellipses.

8. The image matching device according to claim 2, further comprising
a matching correction unit which, when a correction of correspondence information indicating a correspondence relationship between the frontalized ellipse and the circle in the design drawing is input, corrects the correspondence information determined by the ellipse matching unit based on the input correction, and output the corrected correspondence information to the ellipse matching unit.

9. The image matching device according to claim 3, further comprising
a matching correction unit which, when a correction of correspondence information indicating a correspondence relationship between the frontalized ellipse and the circle in the design drawing is input, corrects the correspondence information determined by the ellipse matching unit based on the input correction, and output the corrected correspondence information to the ellipse matching unit.

10. The image matching device according to claim 4, further comprising
a matching correction unit which, when a correction of correspondence information indicating a correspondence relationship between the frontalized ellipse and the circle in the design drawing is input, corrects the correspondence information determined by the ellipse matching unit based on the input correction, and output the corrected correspondence information to the ellipse matching unit.

11. The image matching device according to claim 2, further comprising
a matching result recording which records the position error between the frontalized ellipse output from the ellipse matching unit and the circle in the design drawing on a form.

12. The image matching device according to claim 3, further comprising
a matching result recording which records the position error between the frontalized ellipse output from the ellipse matching unit and the circle in the design drawing on a form.

13. The image matching device according to claim 4, further comprising
a matching result recording which records the position error between the frontalized ellipse output from the ellipse matching unit and the circle in the design drawing on a form.

14. An image matching method comprising:
detecting ellipses around a top surface for each sleeve from an image of a plurality of sleeves,
mapping each detected ellipse to a circle of the sleeve shown in a design drawing, frontalizing the ellipses based on a correspondence relation, and measuring a position error between each frontalized ellipse and corresponding circle in the design drawing, and
displaying the frontalized ellipses and the circles in the design drawing.

15. A non-transitory computer readable storage medium for storing an image matching program for causing a computer to execute:
detecting ellipses around a top surface for each sleeve from an image of a plurality of sleeves,
mapping each detected ellipse to a circle of the sleeve shown in a design drawing, frontalizing the ellipses based on a correspondence relation, and measuring a position error between each frontalized ellipse and corresponding circle in the design drawing, and
displaying the frontalized ellipses and the circles in the design drawing.
